(19) United States
(12) Patent Application Publication
(10) Pub. No.: US 2013/0312016 A1
(43) Pub. Date: Nov. 21, 2013

(54) EMERGENCY EJECTION DEVICE FOR A SLOT-IN OPTICAL DISC DRIVE

(71) Applicant: QUANTA STORAGE INC., Taoyuan County (TW)

(72) Inventors: Yao-Ting Kuo, Taoyuan County (TW); Ko-Han Huang, Taoyuan County (TW); Jen-Chen Wu, Taoyuan County (TW)

(73) Assignee: QUANTA STORAGE INC., Taoyuan County (TW)

(21) Appl. No.: 13/850,302

(22) Filed: Mar. 26, 2013

(30) Foreign Application Priority Data
May 17, 2012 (CN) 201210154730.8

(51) Int. Cl. G11B 17/051

(52) U.S. Cl. CPC G11B 17/051
USPC 720/619

(57) ABSTRACT

An emergency ejection device is disclosed for a slot-in optical disc drive. A thin stick inserts into an ejection hole to rotate an ejection plate for an emergency ejection. A guide pin slides along a guide slot to rotate a release bar such that a clutch gear at the other end of the release bar departs from a self-locking power unit. Then the ejection plate moves a rack to rotate a ratchet unit at a predetermined direction for driving a transmission gear unit to unload a disc.

### BACKGROUND OF THE INVENTION

1. Field of the Invention

The present invention relates to a slot-in optical disc drive, and more particularly, to an emergency ejection device capable of manually unloading an optical disc when the slot-in optical disc drive is abnormal, such as machinery fault or power fault.

2. Description of the Prior Art

A slot-in optical disc drive utilizes a gear unit to drive a bar, a roller and a belt to load and unload an optical disc. The slot-in optical disc drive can not automatically unload the optical disc as machinery fault or power fault. A casing of the slot-in optical disc drive is removed to take the optical disc away. However, the user can not disassemble the casing easily, especially to the slot-in optical disc drive disposed on the vehicle audio, the computer and the high-class audiovisuals, an operator is trained for repair of the slot-in optical disc drive.

Please refer to FIG. 1, FIG. 1 is a diagram of a slot-in optical disc drive 10 disclosed in U.S. Pat. No. 8,042,128 in the prior art. A drive motor 11 is disposed on an end of a drive bar 12 in a self-unlocking manner. A jaw slot 13 is formed on the other end of the drive bar 12 and stretches toward a front end of the slot-in optical disc drive 10. A self-locking worm gear 14 is disposed on a middle of the drive bar 12 to drive a gear unit 15. An end of the gear unit 15 rotates a roller 16, and the other end of the gear unit 15 is actuated by a stir component 17 to drive a clamp unit 18 to clamp or release the optical disc. The stir component 17 is utilized to detect a position of the optical disc. The other end of the gear unit 15 further drives a slides slot 19 to lift and lower the roller 16. When the slot-in optical disc drive 10 is abnormal by the machinery fault or the power fault, the jaw slot 13 is rotated by a conventional tool to prevent the worm gear 14 from blocking the drive bar 12 in an self-locking manner. The worm gear 14 directly rotates a middle gear of the gear unit 15 forwardly or backwardly to decrease a class interval of the gear unit 15, so as to rapidly unload the optical disc.

The conventional slot-in optical disc drive 10 can rotate the drive bar 12 to drive the worm gear 14 to emergently unload the optical disc via rotation of the gear unit 15. However, the low-lead worm gear 14 spends a long period to drive the gear unit 15 to rotate the roller 16 for unloading of the optical disc, which can not unload the optical disc rapidly. Thus, there are problems to be solved about the emergency ejection device of the optical disc drive.

### SUMMARY OF THE INVENTION

A purpose of the present invention is to provide an emergency ejection device for a slot-in optical disc drive for solving above drawbacks. The emergency ejection device utilizes a three-step guide slot formed on an ejection plate to separate a clutch gear disposed on a release bar from a self-locking power unit, so as to manually rotate a transmission gear unit to unload an optical disc.

Another purpose of the present invention is to provide the emergency ejection device for the slot-in optical disc drive. The emergency ejection device utilizes a rack of the ejection plate to directly drive a ratchet unit to rotate the transmission gear unit, so as to unload the optical disc conveniently and rapidly.

Another purpose of the present invention is to provide the emergency ejection device for the slot-in optical disc drive. The emergency ejection device disposes a resilient component on the release bar to prevent the ratchet unit from reversely rotating the transmission gear unit to load the optical disc, so as to effectively unload the optical disc.

In order to achieve the above purposes, the emergency ejection device for the slot-in optical disc drive is disposed inside a casing the of slot-in optical disc drive. An ejection hole is formed on the casing. The slot-in optical disc drive utilizes the self-locking power unit to drive the transmission gear unit. A transmission portion of the transmission gear unit is engaged with a clutch gear via a main gear so as to connect the self-locking power unit. The other transmission portion of the transmission gear unit rotates a roller and drives an ejection mechanism for loading and unloading the optical disc relative to the slot-in optical disc drive. A ratchet unit of the emergency ejection device includes an idler and a ratchet axially connected to each other. The idler is engaged with the transmission gear unit. The ejection plate rotatably pivots to the transmission gear unit. An end of the ejection plate aligns with the ejection hole. The rack and the guide slot are disposed on the other end of the ejection plate. The rack is engaged with and separated from the ratchet according to a movement of the ejection plate. The guide slot is a N-shaped slot. The release bar axially pivots to the main gear. An end of the release bar is fixed on the clutch gear to engage the clutch gear with the main gear. A guide pin protrudes from the other end of the release bar to slidably insert into the guide slot. An end of the recovering spring fixed on the ejection plate provides a resilient force to recover the end of the ejection plate to align with the ejection hole.

The ejection plate does not rotate and the rack is spaced from the ratchet when the slot-in optical disc drive is normal. The guide slot includes a fix area, a clutch area and a drive area. The structural direction of the fix area is perpendicular to a rotating direction of the guide pin for constraining rotation of the guide pin, so that the clutch gear is engaged with the self-locking power unit. A thin stick inserts into the ejection hole to rotate the ejection plate for the emergency ejection. The guide pin slides along the guide slot to rotate the release bar, so that the clutch gear disposed on the other end of the release bar is separated from the self-locking power unit. Meanwhile, the ejection plate drives the rack to rotate the ratchet unit at a predetermined direction for driving the transmission gear unit to unload the optical disc. When the thin stick is drawn, the recovering spring recovers the ejection plate. Meanwhile, the ejection plate drives the rack to rotate the ratchet at the direction opposite to the predetermined direction, the ratchet is idle and does not drive the idler to reversely rotate the transmission gear unit.

The emergency ejection device for the slot-in optical disc drive of the present invention disposes a resilient component stretching from the end of the release bar whereon the guide pin is disposed. An actuating surface structure protrudes from a side of a rear end of the resilient component, and a releasing inclined structure protrudes from the other side of the rear end of the resilient component. At the time, the rear end of the resilient component is engaged with the idler. The ejection plate drives the rack to rotate the ratchet at the direction opposite to the predetermined direction. The idler is unrotatable by constraint of the actuating surface structure of the resilient component, so that the ratchet is idle and does not reversely rotate the ratchet unit. The ejection plate drives the rack to push the ratchet at the predetermined direction. A tooth of the idler moves along the releasing inclined structure of the resilient component to push the resilient component, and the ratchet unit rotates the transmission gear unit to unload the optical disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a slot-in optical disc drive in the prior art.

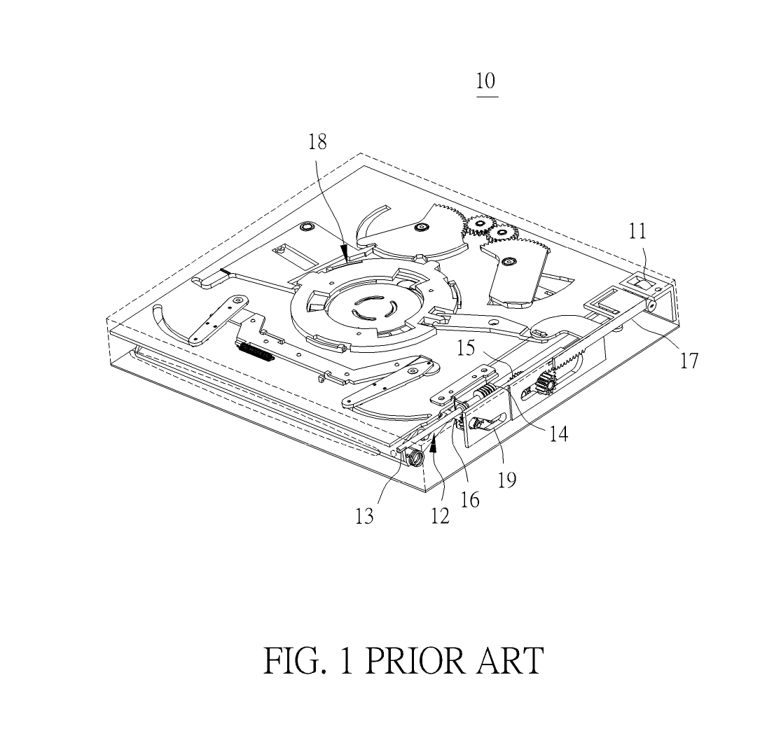

FIG. 2 is a diagram of a slot-in optical disc drive according to an embodiment of the present invention.

FIG. 3 is an enlarged diagram of an emergency ejection device according to the embodiment of the present invention.

FIG. 4 is a diagram of the emergency ejection device separating a clutch gear according to the embodiment of the present invention.

FIG. 5 is a diagram of the emergency ejection device driving a transmission gear unit according to the embodiment of the present invention.

FIG. 6 is a diagram of the emergency ejection device releasing an ejection plate according to the embodiment of the present invention.

FIG. 7 is a diagram of an emergency ejection device according to the other embodiment of the present invention.

FIG. 8 is a diagram of a release bar of the emergency ejection device according to the other embodiment of the present invention.

FIG. 9 is a diagram of the emergency ejection device moving the ejection plate according to the other embodiment of the present invention.

### DETAILED DESCRIPTION

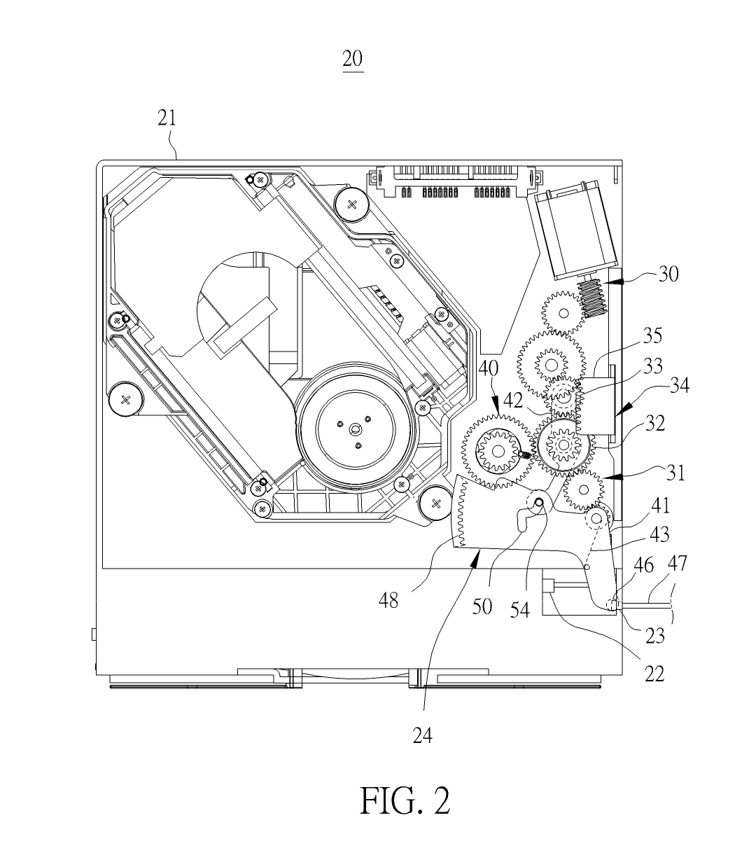

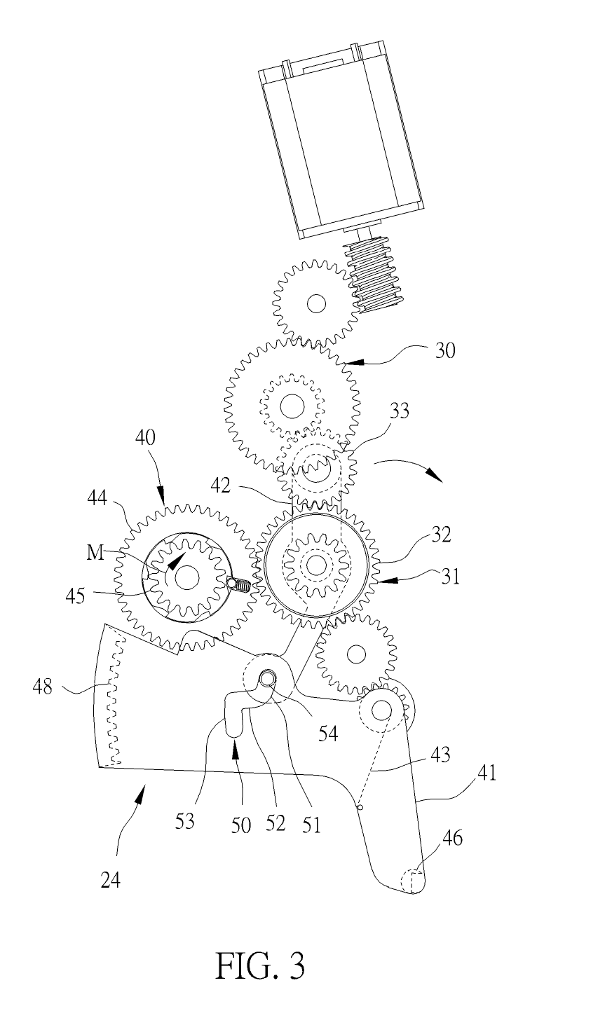

Please refer to FIG. 2 and FIG. 3. FIG. 2 is a diagram of a slot-in optical disc drive 20 according to an embodiment of the present invention. FIG. 3 is an enlarged diagram of an emergency ejection device 24 according to the embodiment of the present invention. The slot-in optical disc drive 20 includes a casing 21 whereon a hollow structure is disposed. A roller 22 is disposed on a front side of the casing 21. Obverse rotation and reverse rotation of the roll 22 is utilized to load and unload an optical disc. An ejection hole 23 is formed on the casing 21 adjacent to the roller 22. The ejection hole 23 can be formed on the front side or a lateral side of the casing 21 according to structural design of the emergency ejection device 24.

The slot-in optical disc drive 20 utilizes a self-locking power unit 30 to drive a transmission gear unit 31. The transmission gear unit 31 includes a plurality of gears engaged with each other. A transmission portion of the transmission gear unit 31 is engaged with a clutch gear 33 via a main gear 32 so as to connect the self-locking power unit 30, therefore, the self-locking power unit 30 can drive the transmission gear unit 31. The other transmission portion of the transmission gear unit 31 rotates the roller 22 and drives an ejection mechanism 34. In addition, the ejection mechanism 34 is actuated when a stir component 35, which is utilized to detect position of the optical disc, slides to be engaged with the transmission gear unit 31, so as to drive a clamp unit to clamp and release the optical disc and to lift and lower the roller 22 for loading and unloading the optical disc (not shown in figures). Motion of the ejection mechanism 34 for loading and unloading the optical disc belongs to scopes of conventional skill, and a detailed description is omitted herein for simplicity.

The emergency ejection device 24 is disposed inside the casing 21. The emergency ejection device 24 includes a ratchet unit 40, an ejection plate 41, a release bar 42 and a recovering spring 43. The ratchet unit 40 includes an idler 44 and a ratchet 45 axially connected to each other. The idler 44 is engaged with the transmission gear unit 31 and is driven by the transmission gear unit 31. The ratchet 45, which rotates at a predetermined direction M (such as a clockwise direction shown in figures), does not rotate relative to the idler 44 due to the single-way rotation and then rotates the idler 44 simultaneously. The ratchet 45, which rotates at a direction opposite to the predetermined direction M (such as a counterclockwise direction shown in figures), does not rotate the idler 44 due to relative idle between the ratchet 45 and the idler 44.

The ejection plate 41 can rotatably pivot to the transmission gear unit 31. An end of the ejection plate 41 aligns with the ejection hole 23. A socket 46 can be disposed on the end of the ejection plate 41, and a thin stick 47 inserts into the ejection hole 23 can be fixed by the socket 46 easily. A rack 48 and a guide slot 50 are disposed on the other end of the ejection plate 41. The rack 48 is disposed on a rear side of the end of the ejection plate 41. The rack 48 can be engaged with and separated from the ratchet 45 according to a movement of the ejection plate 41. The guide slot 50 is a N-shaped slot, which includes a fix area 51, a clutch area 52 and a drive area 53 in sequence. A structural direction of the fix area 51 is substantially identical with a structural direction of the drive area 53, and a structural direction of the clutch area 52 is substantially perpendicular to the structural directions of the fix area 51 and the drive area 53.

The release bar 42 axially pivots to the main gear 32. An end of the release bar 42 is fixed on the clutch gear 33, so that the clutch gear 33 can be engaged with the main gear 32 when the release bar 42 surrounds the main gear 32 to move the clutch gear 33. A guide pin 54 protrudes from the other end of the release bar 42 and slidably inserts into the guide slot 50. An end of the recovering spring 43 fixed on the ejection plate 41 provides a resilient force to the ejection plate 41, so as to recover the end of the ejection plate 41 to align with the ejection hole 23.

As shown in FIG. 3, when the slot-in optical disc drive 20 is normal, the emergency ejection device 24 of the present invention does not rotate the ejection plate 41, the rack 48 is spaced from the ratchet 45, and the clutch gear 33 is engaged with the self-locking power unit 30. Due to rapid rotation of the self-locking power unit 30, the clutch gear 33 is forced to separate from the self-locking power unit 30, and the guide pin 54 disposed on the other end of the release bar 42 is driven to reverse rotation (as an arrow shown in figure). Because the structural direction of the fix area 51 is perpendicular to a rotating direction of the guide pin 54, rotation of the guide pin 54 is constrained, and the clutch gear 33 is stably engaged with the self-locking power unit 30 to keep normal power transmission.

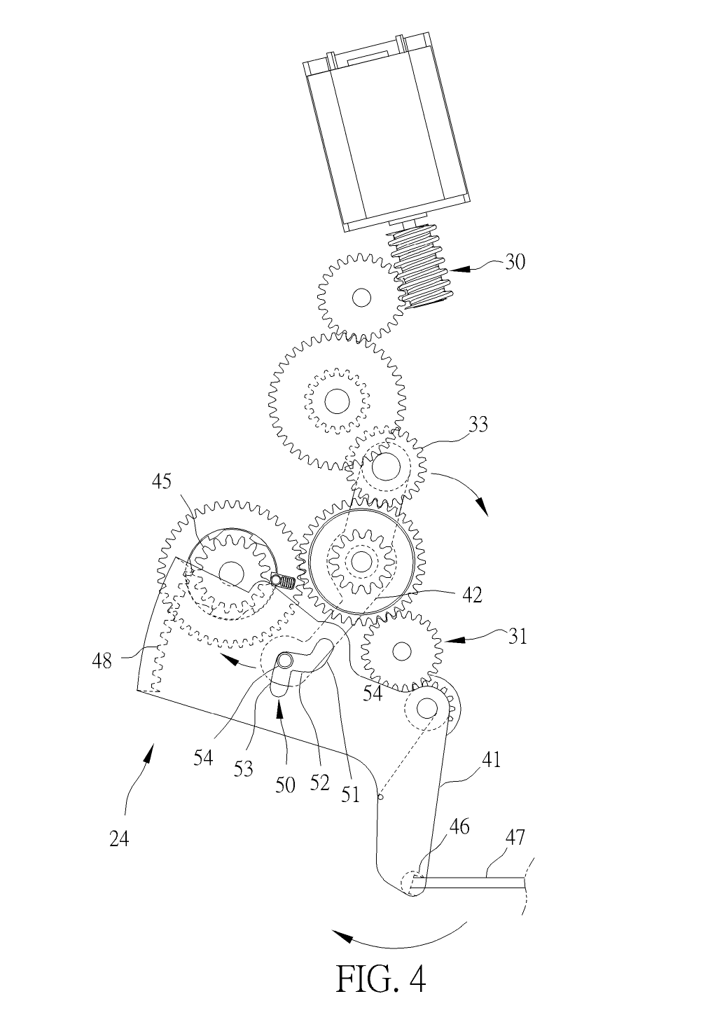

Please refer to FIG. 4. FIG. 4 is a diagram of the emergency ejection device 24 separating the clutch gear 33 according to the embodiment of the present invention. As the slot-in optical disc drive of the present invention unloads the optical disc emergently, the thin stick 47 inserts into the ejection hole 23 to contact the socket 46 disposed on the ejection plate 41. The thin stick 47 rotates the ejection plate 41 to slide the guide pin 54 from the fix area 51 to the clutch area 52 of the guide slot 50. When the guide pin 54 reaches the drive area 53, the release bar 42 is rotated because the structural direction of the clutch area 52 is substantially perpendicular to the structural direction of the fix area 51. Therefore, the clutch gear 33 disposed on the other end of the release bar 42 is separated from the self-locking power unit 30, and the transmission gear unit 31 can freely rotate. Meanwhile, the ejection plate 41 rotates to engage the rack 48 with the ratchet 45, and the ratchet 45 is located over the movement of the ejection plate 41.

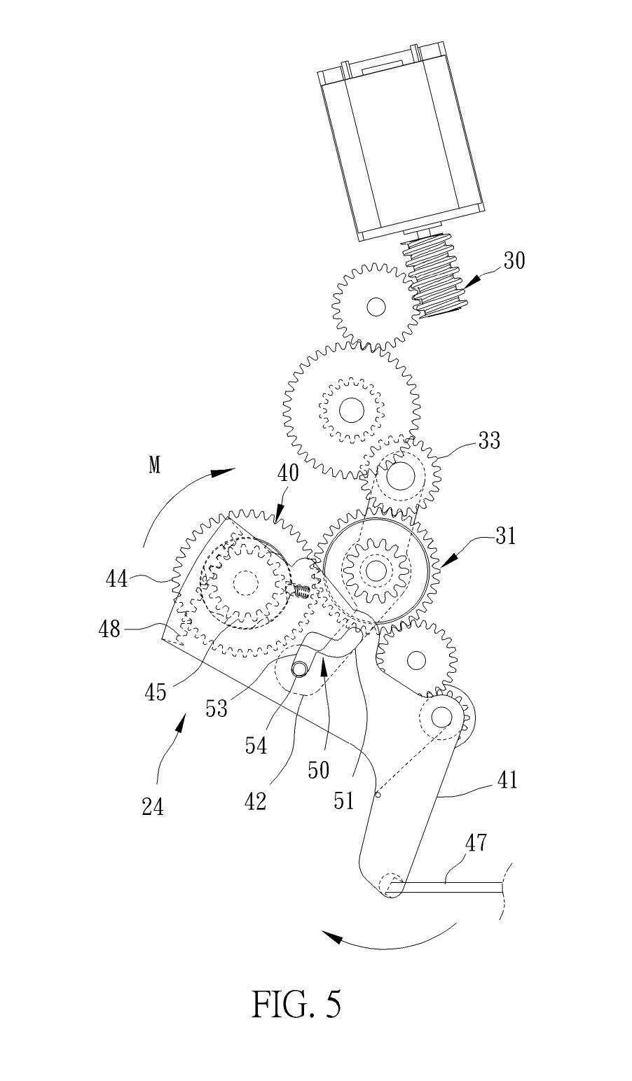

Please refer to FIG. 5. FIG. 5 is a diagram of the emergency ejection device 24 driving the transmission gear unit 31 according to the embodiment of the present invention. When the thin stick 47 rotates the ejection plate 41 continuously, the guide pin 54 slides along the guide slot 50 to move into the drive area 53. Because the structural direction of the drive area 53 is identical with the structural direction of the fix area 51, the release bar 42 does not rotate, the clutch gear 33 is separate from the self-locking power unit 30, and the transmission gear unit 31 is unconstrained. The rack 48 rotates the ratchet 45 at the predetermined direction M, the ratchet 45 drives the idler 44, so that the ratchet unit 40 drives the transmission gear unit 31 to rotate the roller 22 and the ejection mechanism 34, so as to eject the optical disc as part of ejection stroke.

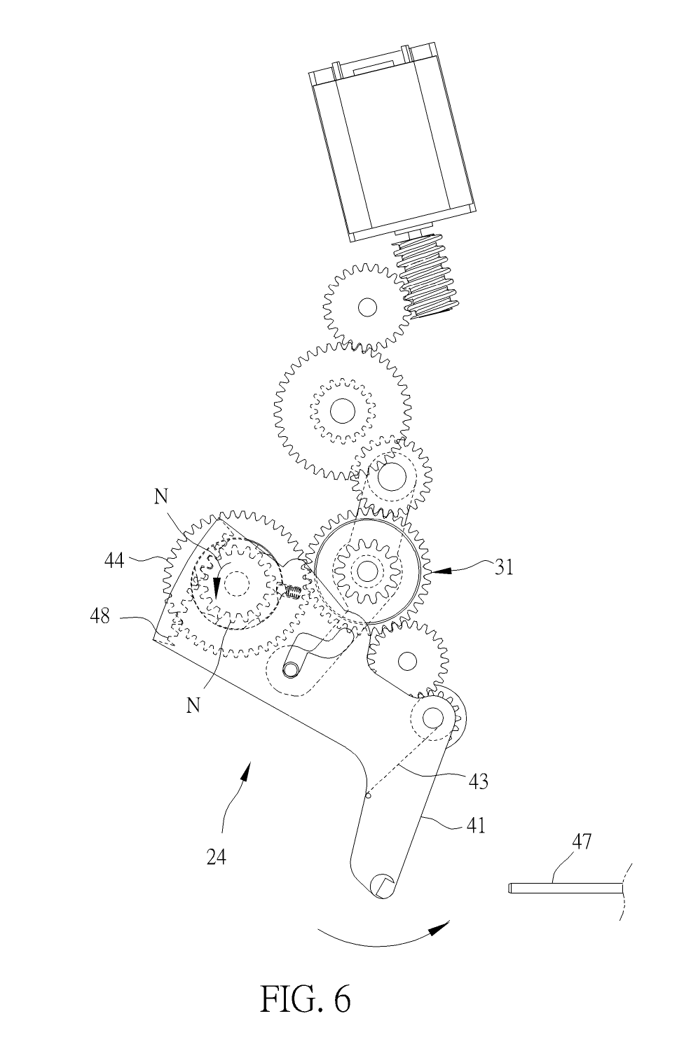

Please refer to FIG. 6. FIG. 6 is a diagram of the emergency ejection device 24 releasing the ejection plate 41 according to the embodiment of the present invention. When the thin stick 47 is drawn, a force applied to the ejection plate 41 is removed, the end of the recovering spring 43 fixed on the ejection plate 41 provides the resilient force to the ejection plate 41, so as to recover the ejection plate 41 to a position that the end of the ejection plate 41 aligns with the ejection hole 23. In the meantime, the rack 48 rotates the ratchet 45 at the direction N opposite to the predetermined direction. Due to an inertia resistance of the slot-in optical disc drive 20 that is generated by connection between the idler 44 and the transmission gear unit 31, the ratchet 45 is idle, the idler 44 and the transmission gear unit 31 do not reversely rotate, and the optical disc is immovable and at the original position. Final, the slot-in optical disc drive 20 is back to a normal operating mode, as shown in FIG. 3. Procedures shown from FIG. 4 to FIG. 6 are repeated to completely unload the optical disc. The emergency ejection device 24 can unload the optical disc by reciprocation of the thin stick 47, such as 3 times to 10 times. The number of times of the reciprocation corresponds to structural design of the emergency ejection device 24.

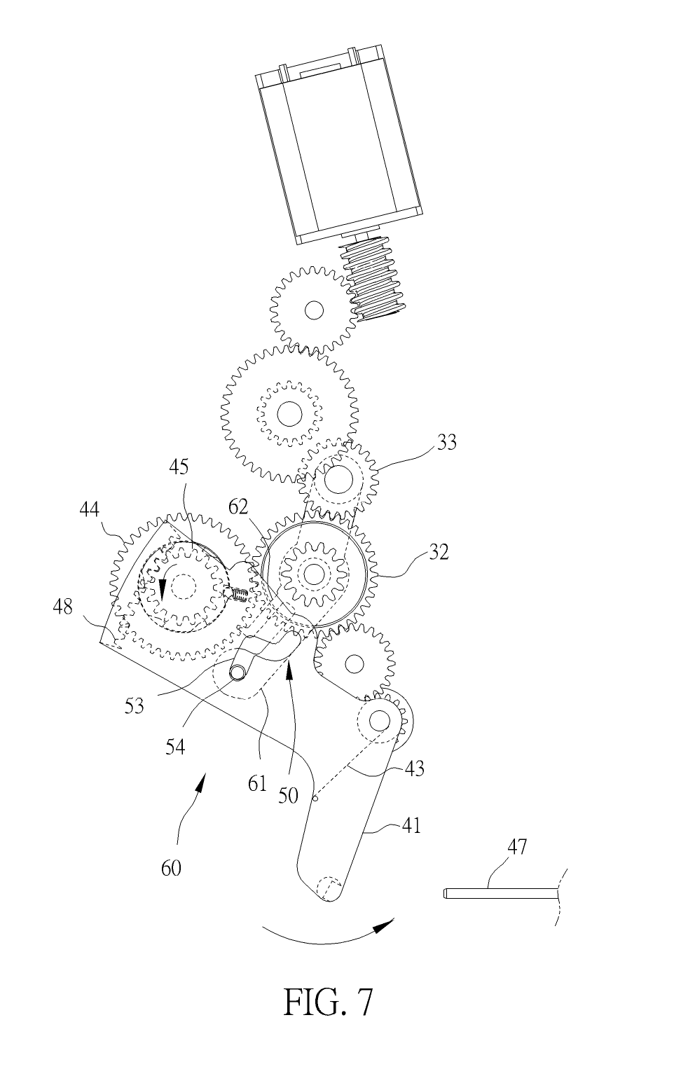

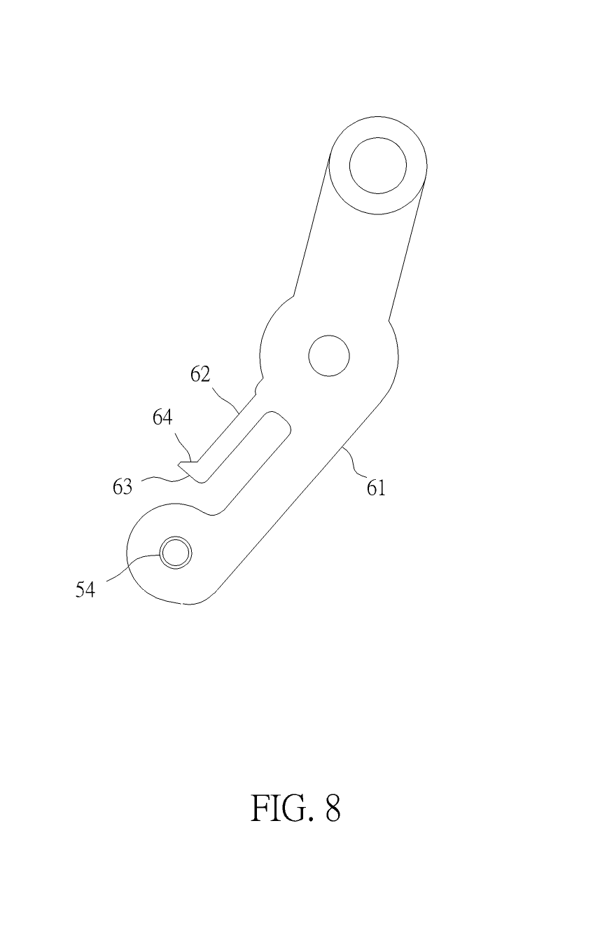

Please refer to FIG. 7 and FIG. 8. FIG. 7 is a diagram of an emergency ejection device 60 according to the other embodiment of the present invention. FIG. 8 is a diagram of a release bar 61 of the emergency ejection device 60 according to the other embodiment of the present invention. In this embodiment, elements having the same numeral as ones of the above-mentioned embodiment have the same structures and functions, and a detailed description is omitted herein for simplicity. Difference between the embodiments is the release bar. The release bar 61 of this embodiment axially pivots to the main gear 32. An end of the release bar 61 is fixed on the clutch gear 33, and the guide pin 54 protrudes from the other end of the release bar 61. However, a resilient component 62 is stretchably disposed on the end, whereon the guide pin 54 is disposed, of the release bar 61. An actuating surface structure 63 protrudes from a side of a rear end of the resilient component 62, and a releasing inclined structure 64 protrudes from the other side of the rear end of the resilient component 62.

As the thin stick 47 is drawn out from the ejection hole 23, the force applied to the ejection plate 41 is removed, and the recovering spring 43 recovers the ejection plate 41 to the initial position. When the guide pin 54 slides along the drive area 53 of the guide slot 50, the ejection plate 41 drives the rack 48 to rotate the ratchet 45 at the direction opposite to the predetermined direction; in the meantime, the rear end of the resilient component 62 is engaged with the idler 44, the idler 44 is unrotatable by constraint of the actuating surface structure 63 of the resilient component 62, so that the idle ratchet 45 is idle and does not reversely rotate the idler 44, and the optical disc is immovable and at the original position. Therefore, the emergency ejection device 60 of this embodiment can utilize the resilient component 62 to prevent the idler 44 from reverse rotation with the ratchet 45.

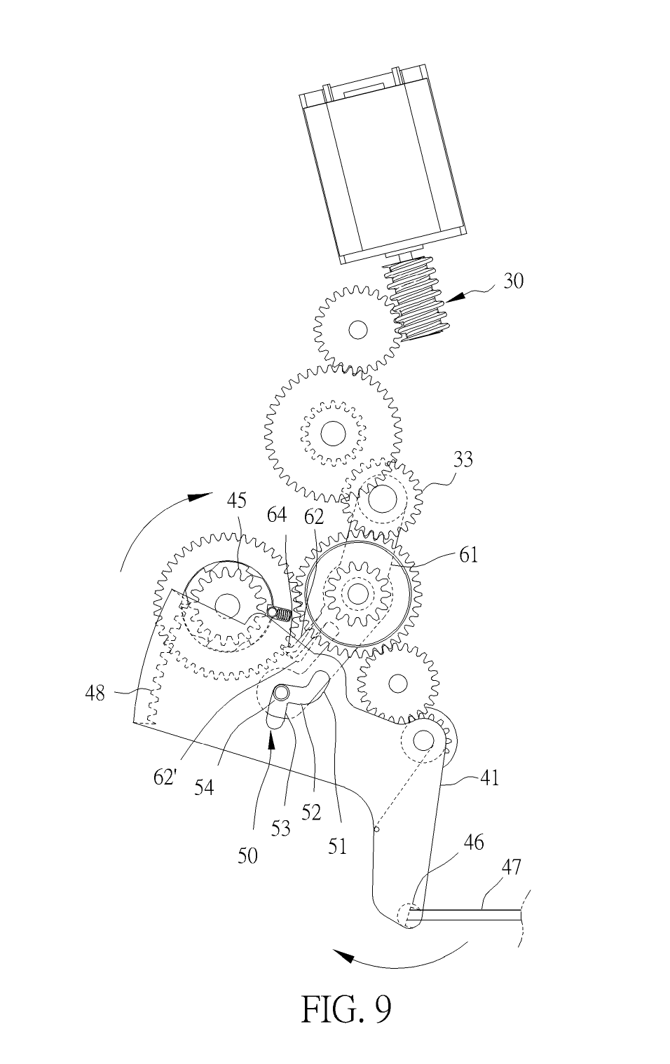

Please refer to FIG. 9. FIG. 9 is a diagram of the emergency ejection device 60 moving the ejection plate 41 according to the other embodiment of the present invention. When the thin stick 47 inserts into the ejection hole 23 for the emergency ejection, the thin stick 47 contacts against the socket 46 disposed on the end of the ejection plate 41 to rotate the ejection plate 41, so as to slide the guide pin 54 along the guide slot 50, to move the guide pin 54 from the fixe area 51 and the clutch area 52 to the drive area 53. Besides, the release bar 61 rotates to engage the rear end of the resilient component 62 with the idler 44, and to separate the clutch gear 33 from the self-locking power unit 30. At the time, the ejection plate 41 drives the rack 48 to push the ratchet 45 at the predetermined direction. A tooth of the idler 44 moves along the releasing inclined structure 64 of the resilient component 62 to push the resilient component 62 toward a position whereon the resilient component 62′ illustrated by dotted line is disposed, and the ratchet unit 40 can rotate the transmission gear unit 31 to unload the optical disc for preventing the resilient component 62 from block of the emergency ejection.

Therefore, the emergency ejection device for the slot-in optical disc drive of the present invention utilizes the three-step guide slot formed on the ejection plate to drive the clutch gear on the release bar to stably engage with and separate from the self-locking power unit. The rack of the ejection plate can directly drive the ratchet to rotate the transmission gear unit for conveniently and rapidly manual emergency ejection of the optical disc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An emergency ejection device for a slot-in optical disc drive, the emergency ejection device being disposed inside a casing the of slot-in optical disc drive, an ejection hole being formed on the casing, the slot-in optical disc drive utilizing a self-locking power unit to drive a transmission gear unit, a transmission portion of the transmission gear unit being engaged with a clutch gear via a main gear so as to connect the self-locking power unit, the other transmission portion of the transmission gear unit rotating a roller and driving an ejection mechanism for loading and unloading an optical disc relative to the slot-in optical disc drive, the emergency ejection device comprising:
a ratchet unit, the ratchet unit comprising an idler and a ratchet axially connected to each other, the idler being engaged with the transmission gear unit;
an ejection plate rotatably pivoting to the transmission gear unit, an end of the ejection plate aligning with the ejection hole, a rack and a guide slot being disposed on the other end of the ejection plate, the rack being engaged with and separated from the ratchet according to a movement of the ejection plate, the guide slot being a N-shaped slot;
a release bar axially pivoting to the main gear, an end of the release bar being fixed on the clutch gear to engage the clutch gear with the main gear, a guide pin protruding from the other end of the release bar to slidably insert into the guide slot; and
a recovering spring, an end of the recovering spring fixed on the ejection plate providing a resilient force to recover the end of the ejection plate to align with the ejection hole;
wherein a thin stick inserts into the ejection hole to rotate the ejection plate for the emergency ejection, the guide pin slides along the guide slot to rotate the release bar, so that the clutch gear disposed on the other end of the release bar is separated from the self-locking power unit, and the ejection plate drives the rack to rotate the ratchet unit at a predetermined direction for driving the transmission gear unit to unload the optical disc.

2. The emergency ejection device of claim 1, wherein the idler rotates and the ratchet does not rotate relative to the idler when the ratchet rotates at the predetermined direction, and the ratchet is idle and does not rotate the idler when the ratchet rotates at a direction opposite to the predetermined direction.

3. The emergency ejection device of claim 2, wherein the predetermined direction is a clockwise direction.

4. The emergency ejection device of claim 2, wherein the recovering spring recovers the ejection plate when the thin stick is drawn, the ejection plate drives the rack to rotate the ratchet at the direction opposite to the predetermined direction, the ratchet is idle and does not drive the idler to reversely rotate the transmission gear unit.

5. The emergency ejection device of claim 1, wherein a socket is disposed on an end of the ejection plate, and the thin stick is fixed by the socket as insertion.

6. The emergency ejection device of claim 1, wherein the guide slot comprises a fix area, a clutch area and a drive area in sequence, a structural direction of the fix area is identical with a structural direction of the drive area, and a structural direction of the clutch area is perpendicular to the structural direction of the fix area.

7. The emergency ejection device of claim 6, wherein the release bar is rotated by the clutch area so as to separate the clutch gear from the self-locking power unit.

8. The emergency ejection device of claim 6, wherein the ejection plate does not rotate and the rack is spaced from the ratchet when the slot-in optical disc drive is normal, the structural direction of the fix area is perpendicular to a rotating direction of the guide pin for constraining rotation of the guide pin, so that the clutch gear is engaged with the self-locking power unit.

9. The emergency ejection device of claim 1, wherein the rack is disposed on a rear side of the end of the ejection plate.

10. The emergency ejection device of claim 1, wherein the thin stick is inserted into and drawn from the ejection hole more than once to unload the optical disc.

11. The emergency ejection device of claim 1, wherein a resilient component stretches from the end of the release bar whereon the guide pin is disposed, an actuating surface structure protrudes from a side of a rear end of the resilient component, and a releasing inclined structure protrudes from the other side of the rear end of the resilient component.

12. The emergency ejection device of claim 11, wherein the release bar rotates to separate the clutch gear from the self-locking power unit, and to move the rear end of the resilient component for engaging with the idler.

13. The emergency ejection device of claim 12, wherein the ejection plate drives the rack to rotate the ratchet at the direction opposite to the predetermined direction, the idler is unrotatable by constraint of the actuating surface structure of the resilient component, so that the ratchet is idle and does not reversely rotate the ratchet unit.

14. The emergency ejection device of claim 12, wherein the ejection plate drives the rack to push the ratchet at the predetermined direction, a tooth of the idler moves along the releasing inclined structure of the resilient component to push the resilient component, and the ratchet unit rotates the transmission gear unit to unload the optical disc.
